(19) United States
(12) Patent Application Publication
(10) Pub. No.: US 2009/0040252 A1
(43) Pub. Date: Feb. 12, 2009

(54) RECORDING APPARATUS AND RECOVERY METHOD

(75) Inventors: Hiroyuki Tanaka, Kawasaki-shi (JP); Koya Iwakura, Kawasaki-shi (JP); Seiji Suzuki, Ebina-shi (JP); Shinya Sonoda, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/178,146

(22) Filed: Jul. 23, 2008

(30) Foreign Application Priority Data
Aug. 10, 2007 (JP) 2007-209184

(51) Int. Cl. B41J 25/308

(52) U.S. Cl. 347/8

(57) ABSTRACT

A recording apparatus includes recording heads mounted in a carriage which can move in a direction vertical to a main surface of a recording medium, a guide rail which guides movement of the carriage, and a recovery unit which recovers recording characteristics. The carriage has a regulating section which regulates vertical upward movement of the carriage. A regulating section distance between the guide rail and regulating section is switchable between a first distance and a second distance which is smaller than the first distance. The regulating section distance is set to the second distance when the recovery unit performs a recovery operation.

### BACKGROUND OF THE INVENTION

1. Field of the Invention

The present invention relates to a recording apparatus which records images on a recording medium using one or more recording heads mounted on a carriage movable along the recording medium, and more specifically, to a recording apparatus which can change the spacing between the recording heads and the recording medium.

2. Description of the Related Art

Generally, a recording apparatus which has a printer, copier, facsimile, or other function is configured to form images (including characters and symbols) on recording media such as paper, cloth, plastic sheets, OHP sheets, and envelopes, based on image recording information using recording heads. The recording apparatus can be of the serial scan type or line scan type. The serial type involves recording an image by alternating between main scanning for moving the recording heads along the recording medium and sub-scanning for conveying the recording medium a predetermined increment. The line type involves recording an image by recording one line at a time using only sub-scanning for conveying the recording medium. Besides, recording apparatus are classified into an inkjet type, thermal transfer type, laser beam type, a thermal recording type, a wire-dot type, and the like according to recording methods. In the case of the recording apparatus of the serial type, the recording heads are generally mounted on a carriage which moves in a main scanning direction and images are recorded by driving the recording heads in sync with movement of the carriage. Recording on an entire recording medium is performed by alternating between recording of one line and a predetermined amount of paper feed.

Japanese Patent Application Laid-Open No. H07-276736 discloses a configuration in which a slide member is mounted in an upper part of a carriage unit, being supported slidably and rotatably with respect to a chassis in an apparatus body. Two or more surfaces are formed on the slide member at different distances from a center of rotation. The slide member is rotated, thereby switching a sliding surface which slides along the chassis, thereby rotating the carriage around a center of a guide shaft, and thereby switching a head gap between a recording medium and recording heads. Consequently, the head gap between the recording medium and recording heads can be increased for recording on a thick recording medium such as envelopes, and decreased for recording on special paper such as glossy paper.

U.S. Pat. No. 6,899,474 discloses a configuration in which cams are installed on both ends of a guide shaft, cam follower surfaces are provided on a chassis in an apparatus body, and the guide shaft can be displaced in a vertical direction when positioned in a sub-scanning direction with respect to the chassis. Consequently, height position of a carriage can be changed by rotationally driving the cam without changing position of the guide shaft in the sub-scanning direction.

U.S. Pat. No. 6,834,925 discloses a configuration in which a carriage is supported by a guide shaft. Rotation direction is regulated by a guide rail on an upper part of the carriage, and a head gap is changed by switching a surface of an abutting member which abuts the guide rail.

On the other hand, Japanese Patent Application Laid-Open No. 2005-329565 proposes a carriage configuration which does not use a guide shaft, where a head gap switchover lever is operated by a user and a carriage unit is supported by a sheet metal rail.

In the recording apparatus with the above configurations, a recovery unit performs a recovery operation to maintain the discharge characteristics of the recording heads. Thus, it is necessary to stably perform suction of ink, wiping of discharge surfaces of the recording heads, and other similar operations. However, a configuration which switches the gap between the recording heads and recording medium needs a complicated switching mechanism, resulting in increased costs and making it difficult to downsize the apparatus.

In the case of the configuration proposed by Japanese Patent Application Laid-Open No. 2005-329565 in which the carriage unit is supported by a sheet metal rail, mechanisms which stabilize the attitude of the carriage unit during the recovery operation by the recovery unit are installed in the carriage unit and chassis unit. Although this configuration can reduce costs using the sheet metal rail instead of a guide shaft, since the mechanisms for attitude stabilization have to be incorporated in a small space, it is difficult to allow removability of the recording heads at the same time.

### SUMMARY OF THE INVENTION

An object of the present invention is to provide a recording apparatus which can properly perform a recovery operation of recording heads using a simple, inexpensive configuration.

An another object of the present invention is to provide an inkjet apparatus for discharging ink from a recording head, comprising: a carriage adapted to carry a recording head; a platen which is configured to support a substrate at a position facing the recording head when being carried by the carriage; a slide member mounted on the carriage, and being moveable relative to the carriage between a first position and a second position; a drive unit which is configured to move the slide member to the first position or the second position; a guide member which is configured to guide movement of the carriage by allowing the carriage to slide along the guide member when the slide member is in the second position, and by allowing the slide member to slide along the guide member when the slide member is in the first position, wherein the distance between the recording head and the platen is larger when the slide member slides along the guide member than when the carriage slides along the guide member; a recovery unit for maintaining the characteristics of the recording head; and a control unit which is configured to move the slide member to the second position before moving the carriage to the recovery means by sliding the slide member along the guide member.

Further features of the present invention will become apparent from the following description of exemplary embodiments with reference to the attached drawings.

### BRIEF DESCRIPTION OF THE DRAWINGS

FIG. 1 is a perspective view of a recording apparatus according to an embodiment of the present invention.

FIG. 2 is a longitudinal sectional view of the recording apparatus according to the embodiment of the present invention.

FIG. 3 is a side view of a carriage unit in FIG. 2.

FIG. 4 is a rear view of the carriage unit in FIG. 3.

FIG. 5 is a perspective view of a carriage and slide member in FIG. 3.

FIG. 6 is a perspective view of a recovery unit.

FIG. 7 is a perspective view of the recovery unit.

FIG. 8 is a block diagram of a control system engaged in a recovery operation.

FIG. 9 is a perspective view of the carriage, slide member and switching member in FIG. 3.

FIG. 10 is a back view when recording head-to-platen distance is decreased.

FIG. 11 is a back view when the recording head-to-platen distance is increased.

FIG. 12 is a side view when the recording head-to-platen distance is decreased.

FIG. 13 is a side view when the recording head-to-platen distance is increased.

FIGS. 14A and 14B are schematic front views illustrating capped recording heads.

FIGS. 15A and 15B are schematic side views illustrating the capped recording heads.

FIG. 16 is a flowchart of a recovery operation of the recording head.

FIG. 17A is a flowchart of a recording operation and FIG. 17B is a flowchart of a capping operation.

FIG. 18 is a top perspective view of a carriage illustrating a configuration in which a guide shaft is used as a carriage support member.

FIG. 19 is a side view of the carriage illustrating the configuration in which the guide shaft is used as the carriage support member.

### DESCRIPTION OF THE EMBODIMENTS

Embodiments of the present invention will now be described with reference to the drawings. The same or corresponding components will be denoted by the same reference numerals in different drawings.

The distance from recording heads 7 to a platen 34 which supports a recording medium is referred to herein as the “recording head-to-platen distance.” Also, the distance from a carriage 50 which carries the recording heads 7 to an undersurface 52a of a guide rail 52 is referred to herein as the “regulating section distance.”

The position of a carriage unit 5a used for recording on recording media other than cardboard or heavy paper or envelopes is referred to as the “normal position.” The recording head-to-platen distance when the carriage unit 5a is located at the normal position is referred to as the “normal recording head-to-platen distance.” The position of the carriage unit 5a used for recording on cardboard or heavy paper is referred to as the “cardboard position.”

Also, the regulating section distance may be referred to herein as a “first distance” when it is large, and as a “second distance” when it is small.

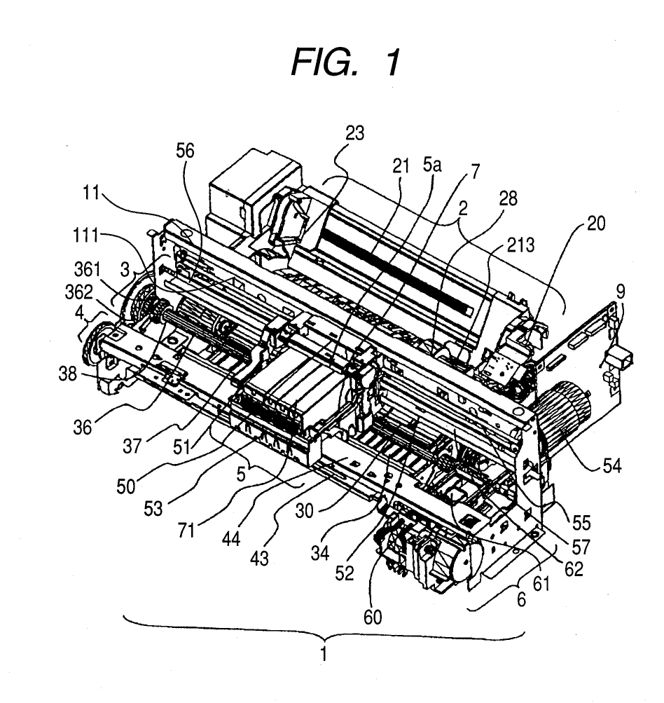

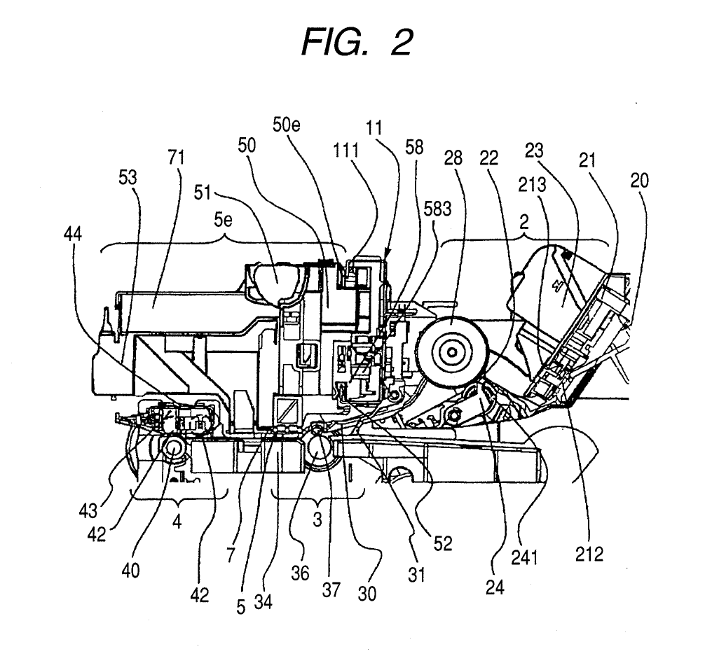

FIG. 1 is a perspective view of a recording apparatus according to an embodiment of the present invention. FIG. 2 is a longitudinal sectional view of the recording apparatus according to the embodiment of the present invention. FIGS. 1 and 2 illustrate a case in which the recording apparatus is an inkjet recording apparatus. The recording apparatus 1 according to the present embodiment includes a paper feed unit 2, paper conveying unit 3, paper ejection unit 4, recording unit 5 and recovery unit 6. The recording unit 5 which serves as a unit of recording is configured to form an image by scanning a recording medium using the recording heads 7 mounted in the carriage 50 which can reciprocate in the case of the serial recording apparatus according to the present embodiment. Also, an electric unit 9 (not shown) is mounted on an apparatus body, where the electric unit 9 includes an electric substrate on which a control unit 200 is mounted.

First, the paper feed unit 2 will be described. The paper feed unit 2 includes a pressure plate 21 on which a recording medium such as recording paper is loaded, paper feed roller 28 which feeds the recording medium, separation roller 241 which separates the recording medium into individual sheets, and return lever 22 used to return the recording medium to a loading position, all of which are mounted on a paper feed base 20. A paper tray (not shown) is mounted on the paper feed base or an apparatus housing (not shown), where the paper tray is used to load and hold the recording medium to be supplied. The paper feed roller 28 has a circular arc section and is disposed close to a reference surface which regulates position of the recording medium in the width direction. The paper feed roller 28 is driven by an LF motor (not shown) via a gear train, the LF motor being a drive source of the paper conveying unit 3 (described later) installed in the paper feed unit 2.

The pressure plate 21 has a movable side guide 23 to regulate the loading position. The pressure plate 21 is able to rotate around a rotating shaft installed on the paper feed base 20 and is biased toward the paper feed roller 28 by a pressure plate spring 212. A separator sheet 213 is installed in that part of the pressure plate 21 which is located opposite the paper feed roller 28. The separator sheet 213 is made of a material with a high friction coefficient to prevent double feeds of the recording medium. The pressure plate 21 is pressed against and spaced from the paper feed roller 28 by a pressure plate cam (not shown). A separation roller holder 24 with the separation roller 241 mounted is rotatably and pivotally supported on the paper feed base 20. The separation roller 241 is biased toward the paper feed roller 28 by a separation roller spring (not shown).

The separation roller 241, which includes a clutch spring (not shown) serving as a torque limiter, rotates when load torque reaches or exceeds a predetermined level. Also, the separation roller 241 is supported in such a way as to be able to be pressed against and be spaced from the paper feed roller 28 via a separation roller release shaft (not shown) and control cam (not shown). The return lever 22 is rotatably mounted near the paper feed roller 28 of the paper feed base 20 to return the recording medium excluding the uppermost layer to the loading position. The return lever 22, which is biased in a release direction by a return lever spring (not shown), can return the recording medium when rotated by the control cam (not shown). In a normal standby state, the paper feed roller 28 has been released by the pressure plate cam and the separation roller 241 has been released by the control cam (not shown). The return lever 22 is installed in a position such as to cover a loading port in order to prevent loaded recording medium from being pushed inward.

When a paper feed operation is started after a standby state, the separation roller 241 is pressed into contact with the paper feed roller 28, being driven by a motor. Then, when the return lever 22 is released, the pressure plate 21 is pressed against the paper feed roller 28. In this state, feeding of the recording medium is started. The recording medium is restricted by a preliminary separator installed on the separation roller holder 24, and consequently only a predetermined number of sheets are delivered to a nip portion between the paper feed roller 28 and separation roller 241. The delivered recording medium is separated by the nip portion, and consequently only the uppermost recording medium is fed to a conveying roller 36 of the paper conveying unit 3. When the recording medium reaches a nip portion between the conveying roller 36 and pinch rollers 37, the pressure plate 21 is released by the pressure plate cam (not shown) and the separation roller 241 is released by the control cam (not shown). Also, the return lever 22 is returned to the loading position by the control cam (not shown). At this time, the recording medium which has reached the nip portion between the paper feed roller 28 and separation roller 241 can be returned to the loading position by the return stroke of the return lever 22.

Next, the paper conveying unit 3 will be described. The paper conveying unit 3 is equipped with a conveying roller 36 which conveys the recording medium. The paper conveying unit also includes a PE (paper end) sensor (not shown). The conveying roller 36 has a structure in which a surface of a metal shaft is coated with fine ceramic particles. Metal parts on both ends of the conveying roller 36 are rotatably and pivotally supported by bearings 38 on the side of a chassis 11. A roller tension spring (not shown) is mounted between the bearings 38 and the conveying roller 36 to apply a predetermined load torque to the conveying roller 36. Consequently, rotation of the conveying roller 36 is stabilized for stable conveyance.

A plurality of pinch rollers 37 is pressed against the conveying roller 36 in such a way as to be able to rotate following the rotation of the conveying roller 36. Each of the pinch rollers 37 is held by a pinch roller holder 30, and is biased toward the conveying roller 36 by a pinch roller spring (not shown) in such a way as to be able to come into contact with the conveying roller 36. This generates the force required to convey the recording medium. In this case, a rotating shaft of the pinch roller holder 30 is rotatably mounted on bearings of the chassis 11. A sensor lever 31 is installed on the pinch roller holder 30 to inform the PE sensor (not shown) about detection of the front end and rear end of the recording medium. The platen 34 is placed downstream along a conveying direction of the conveying roller 36 to guide and support the recording medium during recording. The platen 34 is mounted on the chassis 11.

The recording medium fed from the paper feed unit 2 is sent into the nip portion between the conveying roller 36 and pinch rollers 37, being guided by the pinch roller holder 30. While the conveying roller 36 remains stopped, head-alignment (or head-registration) of the recording medium is made by further feeding the recording medium by a predetermined amount with a leading edge of the recording medium struck against the nip portion. At the same time, the leading edge of the recording medium is detected by the sensor lever 31 to find a recording start position of the recording medium. Then, the conveying roller 36 is rotated by the LF motor to convey the recording medium to a recording start position on the platen 34. A rib is formed on the platen 34 to serve as a reference position for conveyance. Rib layout is used to manage the recording head-to-paper distance between the recording medium and recording heads 7 and is used in conjunction with the paper ejection unit 4 (described later) to regulate waving of the recording medium.

The conveying roller 36 is driven by rotation of the LF motor (not shown) which is a DC motor, the rotation being transmitted to a pulley 361 installed on a roller shaft, via a timing belt (not shown). Also, a code wheel 362 is installed on the roller shaft of the conveying roller 36 to detect an amount of conveyance. Markings are formed around the code wheel 362 at a rate of 150 to 300 markings per inch of arc length. An encoder sensor (not shown) is mounted on the chassis 11 at a position near the code wheel 362 to read the markings as the shaft rotates.

Next, the recording unit 5 will be described. The recording heads 7 which form images on the recording medium are installed downstream along the conveying direction of the conveying roller 36 and at a position facing the platen 34. The recording heads 7 are mounted in the carriage 50 which can reciprocate in the width direction of the recording medium. That is, the recording apparatus according to the present embodiment uses a serial recording method. The recording unit 5 includes the carriage unit 5a and a drive mechanism for the carriage unit 5a (or carriage 50), where the carriage unit 5a in turn includes the carriage 50 and the recording heads 7 mounted in the carriage 50. The recording unit 5 also includes the platen 34 which guides and supports the recording medium at a position opposite the recording heads. The recording heads 7 according to the present embodiment are inkjet recording heads capable of color recording. Therefore, the number of recording heads 7 corresponds to the number of ink colors. Separate ink tanks 71 are replaceably attached to the recording heads.

The recording heads 7 are inkjet recording heads which record images on a recording medium by discharging ink from discharge orifices to the recording medium based on image information. It is necessary to provide a predetermined distance (e.g., approximately 0.5 mm to 3.0 mm) between the ink discharge surfaces (where the discharge orifices are arranged) of the recording heads and a recording surface of the recording medium. As the recording medium, various materials in various forms are available including paper, cloth, plastic sheets, OHP sheets, and envelopes, provided that the ink droplets falling on the materials can form images thereon. Regarding an ink discharge method of the recording heads 7, any method may be used out of available methods which include a method using an electrothermal converting element and a method using an electromechanical converting element as a unit for generating discharge energy. For example, the recording heads 7 according to the present embodiment heat ink in the discharge orifices using a heater or other electrothermal converting element and discharge the ink using boiling caused by the heat. That is, the recording heads 7 discharge ink selectively from the discharge orifices of the recording heads 7 using pressure changes caused by growth and contraction of bubbles generated in the ink by heat and thereby record images on the recording medium.

The carriage unit 5a includes the carriage 50 with the recording heads 7 mounted on it. The recording heads 7 are positioned and held in a predetermined place on the carriage 50 by a head set lever 51. The carriage unit 5a is guided and supported by a guide member (guide rail) 52 and a part 111 of the chassis 11 installed on the apparatus body, in such a way as to be able to reciprocate in a main scanning direction, normally at right angles to the conveying direction (sub-scanning direction) of the recording medium. In this case, the carriage unit 5a is guided and supported with an abutting surface 50e on the upper end of the carriage 50 being placed in abutment with part 111 of the chassis 11.

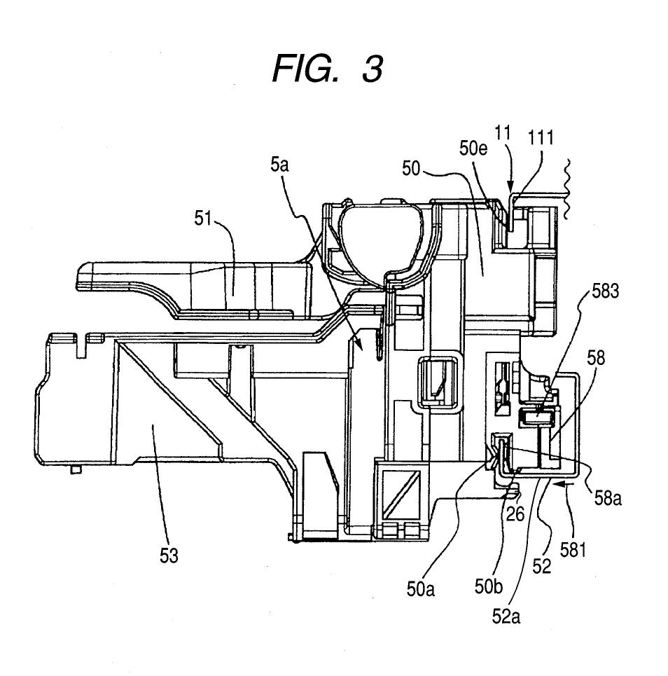

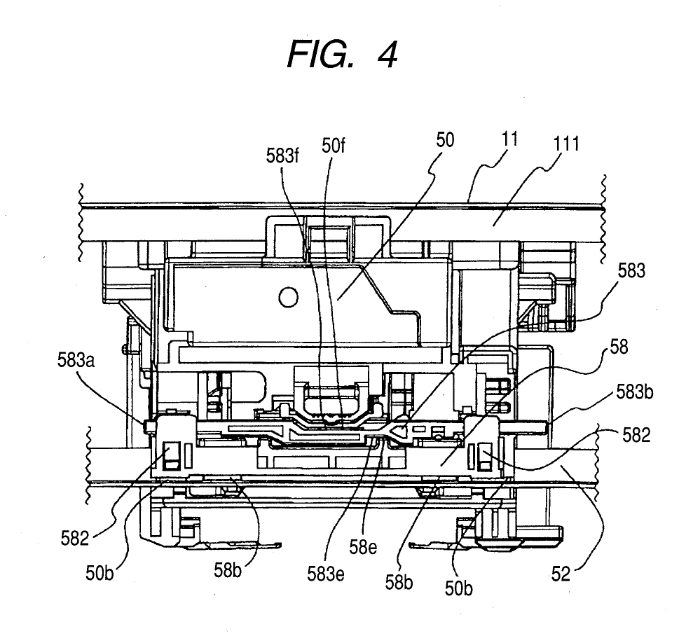

FIG. 3 is a side view of the carriage unit 5a in FIG. 2. FIG. 4 is a rear view of the carriage unit 5a in FIG. 3. In FIGS. 1 to 4, the guide rail 52 (which is a guide member of the carriage unit 5a) has an approximately L-shaped section. A slide member 58 which can slide along the guide rail 52 is mounted on the carriage 50. The slide member 58 is mounted in such a way as to be vertically displaceable relative to the carriage 50. Also, the slide member 58 is intended to stabilize attitude of the carriage 50 in the sub-scanning direction with respect to the guide rail 52. For that, a spring 581 is installed to bias the slide member 58 downstream along the conveying direction of the recording medium. That is, the attitude of the carriage 50 in the sub-scanning direction is stabilized by the guide rail 52 being put between the carriage 50 and slide member 58 by biasing force of the spring 581.

A sliding surface (vertical sliding surface) 50b capable of abutting a horizontal part of the guide rail 52 is formed in lower part of the carriage 50. Also, a sliding surface (vertical sliding surface) 58b capable of abutting the horizontal part of the guide rail 52 is formed in lower part of the slide member 58. The vertical sliding surfaces 50b and 58b can regulate vertical position of the carriage 50 by abutting the guide rail 52 under the weight of the carriage 50. Also, attitude of the carriage 50 in a rotational direction is stabilized by abutting the part 111 of the chassis 11 against the abutting surface 50e on the upper end of the carriage 50. Position adjustments of the carriage 50 are made by adjusting mounting position of the guide rail 52 with respect to the chassis 11 when the apparatus is assembled.

In the lower part of the carriage 50, regulating sections 26 are formed at positions opposite the vertical sliding surface 50b. The regulating sections 26 are intended to prevent the carriage 50 from falling off the guide rail 52 during scanning as well as during handling and distribution. The regulating sections 26 prevent the carriage 50 from falling off the guide rail 52 by regulating vertically-upward travel of the carriage 50 which can move vertically with respect to the recording medium. That is, the regulating sections 26 prevent falls by abutting against lower part (the undersurface 52a) of the guide rail 52.

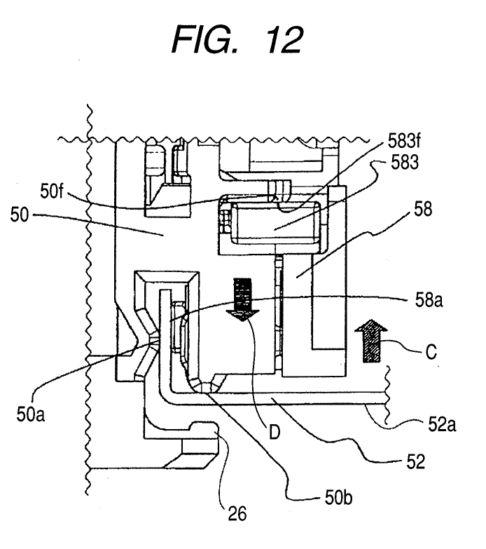

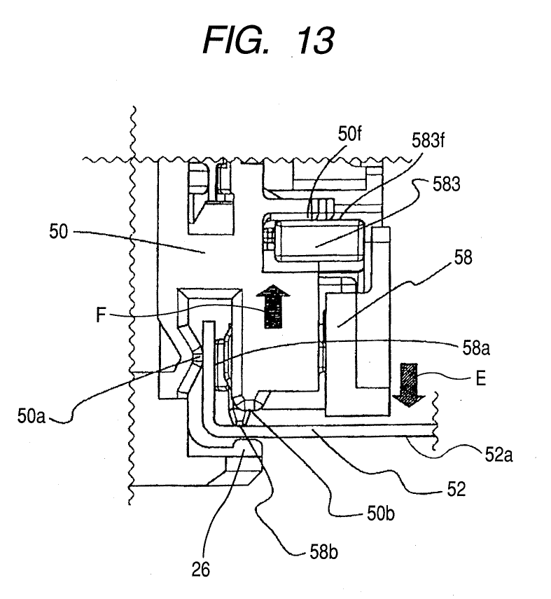

A clearance is provided between the regulating sections 26 and the undersurface 52a of the guide rail 52. As described above, according to the present embodiment, this clearance is referred to as the regulating section distance (see FIGS. 12 and 13). When the recording head-to-platen distance is large (cardboard position), the regulating section distance is small (second distance). On the other hand, when the recording head-to-platen distance is small (normal position), the regulating section distance is large (first distance).

Furthermore, the regulating sections 26 have a function to reduce tilting of the carriage 50 by decreasing the regulating section distance (to the second distance) to increase reliability of the carriage 50 during recording head recovery operations.

A carriage cover 53 is mounted on the carriage 50. The carriage cover 53 functions as a guide member when a user mounts the recording heads 7 on the carriage. The carriage cover 53 also functions as a member which holds the ink tanks 71. The carriage 50 is driven by a carriage motor 54 mounted on the chassis 11, via a timing belt 55. The timing belt 55 is installed under constant tension applied by an idle pulley 56 disposed on the side opposite the carriage motor 54. The timing belt 55 is coupled to the carriage 50. A code strip 57 is provided in parallel to the timing belt 55 to detect position of the carriage 50. Markings are formed on the code strip, for example, at a rate of 150 to 300 markings per inch. An encoder sensor (not shown) is mounted to read the markings on the code strip 57 on the carriage 50.

By being displaced vertically relative to the carriage 50 as described later, the slide member 58 switches height position of the carriage 50 with respect to the guide rail 52. The switching of the height position of the carriage 50 enables switching of the recording head-to-platen distance, i.e., the distance between the recording heads 7 and recording medium or between the recording heads 7 and platen 34.

Next, the paper ejection unit 4 will be described. The paper ejection unit 4 includes a paper ejection roller 40 placed downstream of the recording heads 7 along the conveying direction, spurs 42 which can rotate following the rotation of the paper ejection roller 40 by abutting the paper ejection roller 40 under a predetermined pressure, and a gear train which transmits driving force of the conveying roller 36 to the paper ejection roller 40. According to the present embodiment, the paper ejection roller 40 is mounted on the platen 34. The paper ejection roller 40 has a structure in which a plurality of rubber rollers is mounted on a metal shaft. The paper ejection roller 40 rotates in sync with the conveying roller 36 as the driving force of the conveying roller 36 is transmitted via an idler gear. The plurality of rubber rollers of the paper ejection roller 40 corresponds to the plurality of spurs 42. Each spur 42 is produced by molding a resin integrally with a thin stainless steel plate which has a plurality of protrusions around it. The spurs 42 are mounted on a spur holder 43 using spur springs (not shown) which are cylindrical coil springs. Also, the spurs 42 are pressed into contact with the paper ejection roller 40 by the spur springs.

The spurs 42 are functionally divided into two types. One of the types mainly generates force used to convey the recording medium when pressed against the rubber rollers. The other type mainly prevents the recording medium from rising during recording, by being placed between rubber rollers. Also, a spur stay 44 made of a plate-like metal member is installed to prevent deformation of the spur holder 43 and chassis 11. With the above configuration, the recording medium on which an image has been formed by the recording unit 5 is conveyed by being pinched in a nip portion between the paper ejection roller 40 and spurs 42 and ejected to a paper ejection tray (not shown) outside the apparatus.

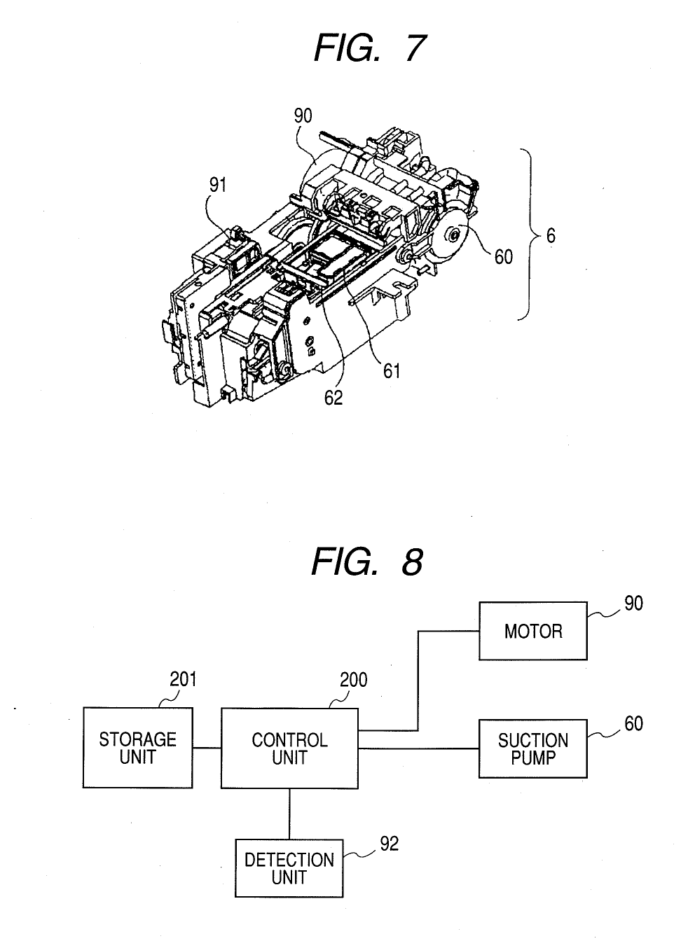

Next, the recovery unit 6 will be described. FIGS. 6 and 7 are perspective views of the recovery unit 6. FIG. 8 is a control block diagram of a control system engaged in a recovery operation.

Inkjet recording apparatuses are equipped with a recovery unit 6 to prevent the discharge orifices of the recording heads from being clogged, and to maintain and recover recording characteristics, i.e., ink discharge characteristics.

The recovery unit 6 includes a suction pump 60, cap 61, wiper 62, motor 90 and carriage lock member 91. The cap 61 closely adheres to and seals the discharge surfaces of the recording heads 7, covering the discharge orifices, and thereby prevents the ink in the recording heads from drying. The suction pump 60 operates with the discharge orifices sealed by the cap 61, sucks ink from the discharge orifices, and refreshes the ink in the discharge orifices. The wiper 62 wipes and cleans the discharge surfaces of the recording heads. The suction pump 60 may be a tube pump which squeezes a tube connected to the cap 61 and causes a negative pressure generated in the tube to act on the discharge orifices. The motor 90 is a drive source of the recovery unit 6. The carriage lock member 91 performs positioning and locking of the carriage 50 and recovery unit 6 in the main scanning direction.

The control unit 200 drives the motor 90 and suction pump 60 based on the current recording head-to-platen distance, current regulating section distance stored in a storage unit 201, or detection results produced by a detection unit 92. As described later, the inkjet recording apparatus according to the present embodiment allows the regulating section distance to be selected from the first distance and the second distance smaller than the first distance. The control unit 200 selects the second distance as the regulating section distance when a recovery operation is performed by the recovery unit 6. The detection unit 92 detects whether the recording heads 7 are capped and whether the recording head-to-platen distance is set to the normal position or the cardboard position.

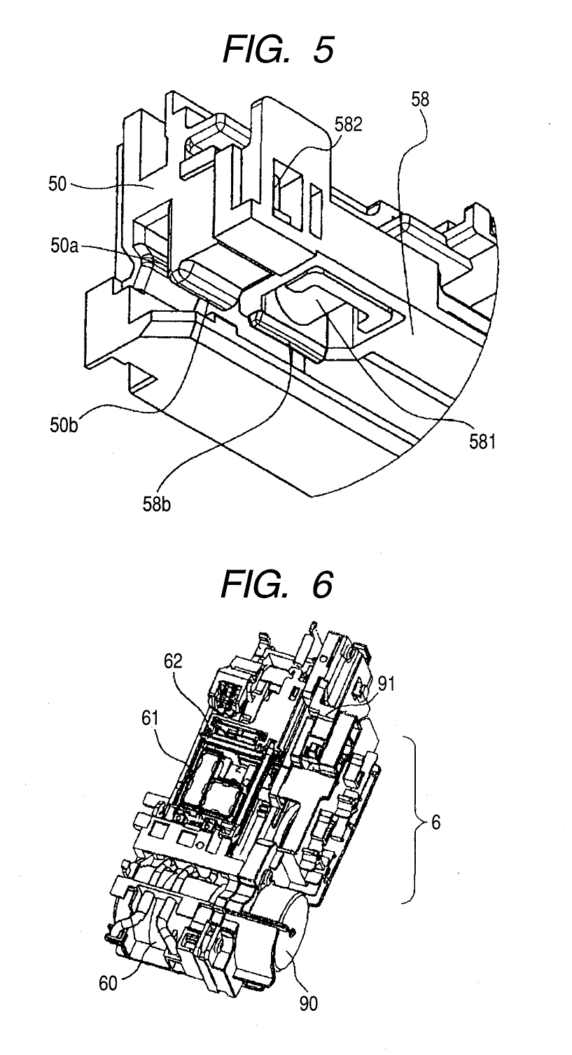

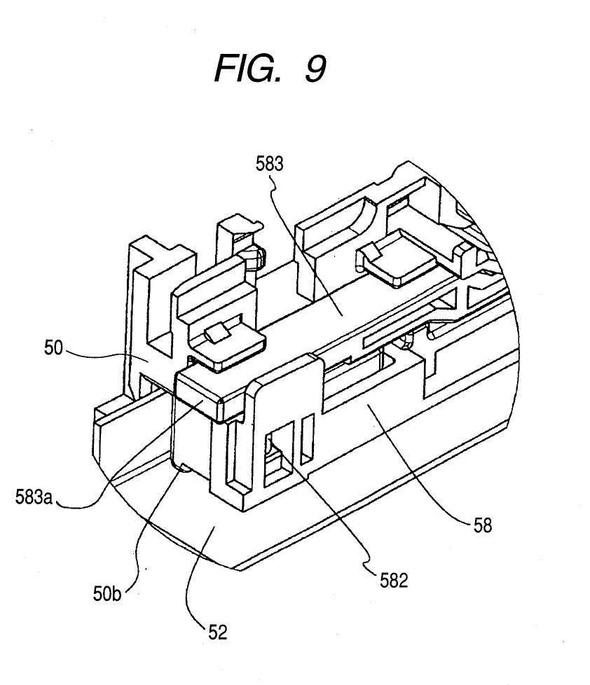

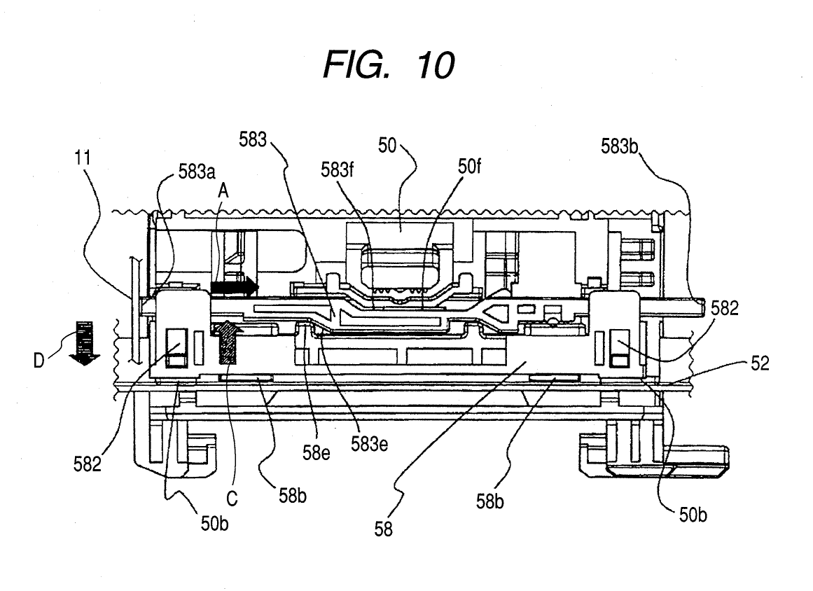

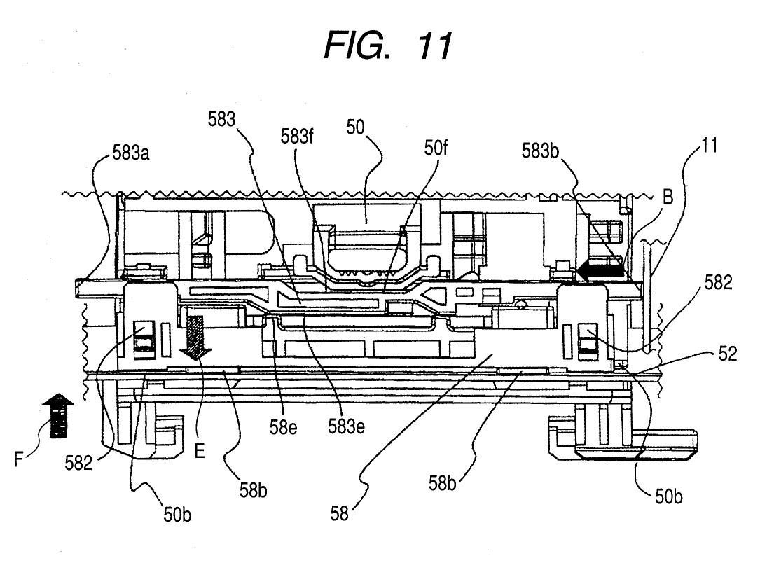

FIG. 5 is a perspective view of the carriage and slide member in FIG. 3. FIG. 9 is a perspective view of the carriage, slide member and switching member in FIG. 3. FIG. 10 is a back view when the recording head-to-platen distance is decreased. FIG. 11 is a back view when the recording head-to-platen distance is increased. FIG. 12 is a side view when the recording head-to-platen distance is decreased. FIG. 13 is a side view when the recording head-to-platen distance is increased. Configuration and operation of the slide member 58 used to switch the recording head-to-platen distance, i.e., the distance between the recording heads 7 and platen 34, will be described with reference to FIGS. 1 to 11. In FIGS. 3 to 11, the carriage 50 is guided and supported by the guide rail 52 and the part 111 installed on the chassis 11 in such a way as to be able to reciprocate in a stable attitude.

As shown in FIG. 3, upstream of the carriage 50 along the conveying direction, the slide member 58 is installed behind the carriage 50 with an L-shaped vertical face turned upstream in such a way as to be vertically displaceable relative to the carriage 50. The spring 581 is installed between the carriage 50 and slide member 58 to bias the slide member 58 toward the carriage 50 downstream along the conveying direction (leftward in FIG. 3). The biasing force of the spring 581 puts the guide rail 52 installed on the chassis 11 between a horizontal sliding surface 50a of the carriage 50 and horizontal sliding surface 58a of the slide member 58. This regulates position of the lower part of the carriage 50 in the conveying direction and thereby stabilizes the attitude of the carriage.

Height position of the carriage 50 with respect to the guide rail 52 is designed to be switchable by abutting the lower part of the carriage 50 or lower part of the slide member 58 against the guide rail 52 under the weight of the carriage 50. That is, to decrease the recording head-to-platen distance, the vertical sliding surface 50b of the carriage 50 is abutted against horizontal part of the guide rail 52 as shown in FIG. 3. In this state, with the carriage unit 5a moving along the guide rail 52 and sliding against part 111 of chassis 11, an image is formed by the ink discharged from the recording heads 7 to the recording medium, based on a signal from the electric unit 9. These conditions are used when recording is done on recording medium other than cardboard, i.e., when high image quality is required. The position of the carriage 50 under these conditions is referred to as normal position and the recording head-to-platen distance is referred to as “normal recording head-to-platen distance.”

Conditions of the normal position will be further described below. At this time the slide member 58 is biased in the conveying direction by the spring 581. In the conveying direction, the sliding surface 58a slidably abuts the guide rail 52. In the height direction, the slide member 58 does not contact the guide rail 52 because the sliding surface 58b of the slide member is located higher than the sliding surface 50b of the carriage 50. Also, a switching member 583 is mounted between the slide member 58 and the carriage 50 as shown in FIG. 4, where a switching member 583 can move relative to the carriage 50 in a travel direction of the carriage. Thus, at the normal position, the slide member 58 is held in an elevated position by an upward-biasing spring 352 installed between the slide member 58 and carriage 50, as shown in FIGS. 3 to 5. Consequently, under these conditions, the slide member 58 (and its sliding surface 58b) does not touch the guide rail 52. Also, the slide member 58 is biased downward by biasing springs 582 installed on both sides and positioned in abutment with the carriage 50 in a vertically downward direction. Also, the slide member 58 is positioned with respect to the carriage 50 in the main scanning direction at locations of the biasing springs 582 on both sides.

Near the back of the carriage 50, the switching member 583 capable of relative movement in the travel direction of the carriage is mounted between the carriage 50 and slide member 58. The switching member 583 is elongated in a direction across the conveying direction (i.e., in the main scanning direction) and is capable of relative movement in the direction of its length. Also, when the carriage 50 moves, ends 583a and 583b of the switching member 583 hit part of the apparatus body (flanks of the chassis 11 in the case of the illustrated example), thereby allowing the switching member 583 to regulate position of the carriage 50 in the direction of the relative movement (i.e. in the main scanning direction). The switching member 583 is positioned in the conveying direction by being pinched between the carriage 50 and slide member 58 as shown in FIG. 9. Vertically, the switching member 583 is positioned in the upward direction by abutting the carriage 50 and positioned in the downward direction by abutting the slide member 58. The positioning is stabilized by biasing spring force acting between the carriage 50 and slide member 58.

Next, a switching operation performed by the slide member 58 and switching member 583 of the above configuration with respect to the recording head-to-platen distance between the recording heads 7 and platen 34 will be described with reference to FIGS. 10 to 13. FIGS. 10 and 11 illustrate a state which exists when the carriage unit 5a is at the normal position. When the recording unit 5 records on the recording medium using the recording heads 7, it is necessary to establish the position of the carriage 50 in the main scanning direction. For that, first, the carriage 50 is moved leftward in FIG. 10 and the left end (in FIG. 10) 583a of the switching member 583 (in FIG. 10) is caused to hit a flank of the chassis 11. Consequently, an initial position of the carriage 50 is established. In this state, the switching member 583, which has its position regulated in the main scanning direction by abutting part of the carriage 50, does not move further in the direction of arrow A in FIG. 10.

As described above, according to the present embodiment, the initial position of the carriage 50 is located by hitting the switching member 583 against the chassis 11. Alternatively, the initial position may be located by hitting an end of the carriage 50 against the chassis 11 after the switching member 583 moves a predetermined amount. This configuration allows more accurate position location to be implemented by reducing the number of parts involved in the initial position location. In this way, under the conditions of the normal position, a normal recording operation is performed on a normal recording medium not thicker than a set thickness.

On the other hand, when recording on cardboard or a recording medium which curls easily, it is necessary to increase the recording head-to-platen distance between the recording heads 7 and platen 34. For that, it is necessary to switch the carriage 50 to a higher position than the normal position at which the carriage 50 abuts the guide member 52. The position of the carriage 50 at this time is referred to as a cardboard position as described above. At the normal position such as shown in FIGS. 10 and 12, the carriage unit 5a abuts the guide member 52 via its vertical sliding surface 50b under its own weight. At this time, the slide member 58 is positioned in the upward direction by being biased upward by the springs 582. Consequently, the sliding surface 58b of the slide member 58 is located above the guide member 52, being clear of the guide member 52.

The switching member 583 has its relative position regulated in the travel direction and thereby changes the vertical position of the slide member 58 relative to the carriage 50. An upward-facing surface 583f formed on part of the switching member 583 abuts a downward-facing surface 50f formed on part of the carriage 50. That is, the carriage 50 is supported by the switching member 583 via the catching surface 50f formed on the carriage 50 and via the carriage supporting surface 583f formed on the switching member 583. Thus, relative vertical position of the switching member 583 and carriage 50 remains unchanged. On the other hand, a cam surface 583e is formed on a downward-facing surface of the switching member 583 and a protrusive abutting portion 58e is formed on an upward-facing surface of the slide member 58 to abut the cam surface 583e. If abutting position on the cam surface 583e of the abutting portion 58e is changed through relative movement of the switching member 583, vertical position of the slide member 58 relative to the carriage 50 can be changed. Even when the relative position changes in this way, position regulation can be carried out in a stable manner using the biasing spring force acting between the carriage 50 and slide member 58.

With the above configuration, during recording at the cardboard position, the carriage unit 5a is moved rightward in FIGS. 10 and 11. This causes the right end 583b of the switching member 583 to hit a flank of the chassis 11. Consequently, the switching member 583 starts to move in the direction of arrow B in FIG. 11. As a result, the slide member 58 is moved in the direction of arrow E in FIGS. 11 and 13 by the cam surface 583e provided on the switching member 583. That is, the slide member 58 is displaced downward relative to the carriage 50, placing the sliding surface 58b of the slide member below the sliding surface 50b of the carriage. This causes the sliding surface 58b of the slide member 58 to abut the guide rail 52 and conversely displaces the carriage 50 upward away from the guide rail 52. In so doing, the slide member 58 tends to be displaced further downward by the cam surface 583e of the switching member 583, but the downward displacement is blocked by the abutment with the guide rail 52.

That is, the sliding surface 58b of the slide member 58 abuts the guide rail 52, causing a reaction force from the guide rail 52 to be transmitted to the switching member 583 via the cam surface 583e and further transmitted, via the switching member 583, to the carriage 50 which regulates upward travel. Consequently, the carriage 50 is displaced in the upward direction indicated by arrow F in FIGS. 11 and 13. When the right end 583b of the switching member 583 is pushed further in the direction of arrow B by the flank of the chassis 11, part of the switching member 583 abuts the carriage 50, preventing the switching member 583 from moving further upward. These are the conditions of the cardboard position at which the recording head-to-platen distance between the recording heads 7 and platen 34 is increased.

At the cardboard position, since the carriage 50 has moved upward from the normal position, the vertical sliding surface 50b of the carriage 50 is spaced from the guide rail 52. Thus, the vertical position of the carriage 50 is regulated by the vertical sliding surface 58b of the slide member 58. In this state, with the carriage unit 5a moving in the main scanning direction, an image is formed by the ink discharged from the recording heads 7 to a thick recording medium such as cardboard or an envelope based on a signal from the electric unit 9.

According to the present embodiment, height position of the slide member 58 is switched through relative movement of the switching member 583 in the travel direction of the carriage. Alternatively, with the switching member 583 eliminated, the user may be allowed to switch from the normal position to the cardboard position by moving the carriage unit 5a manually. Also, the switching between the normal position and cardboard position may also be performed through manual operation of the slide member 58. This will enable reduction in the number of parts and improvement in inter-component accuracy by eliminating the switching member 583.

The embodiment described above is configured to abut the carriage 50 or switching member 583 against one flank of the chassis 11 for the initial position-location of the carriage 50. This allows the carriage unit 5a to be set at the normal position. Also, if the carriage 50 is abutted against the opposite flank of the chassis 11, the carriage unit 5a can be set at the cardboard position. That is, the carriage unit 5a can always be set at the normal position via the initial position location of the recording heads 7 at the start of recording. Consequently, the recording head-to-platen distance can be established using an inexpensive configuration without adding a sensor or drive mechanism.

Consequently, various operations for which the height position of the carriage unit 5a is important can be performed in a stable manner, including not only operations needed to maintain high quality such as proper setting of the recording head-to-platen distance for the recording heads 7, but also recovery operations such as a capping operation with the cap 61 and wiping/cleaning operation with the wiper 62 of the recovery unit 6. Also, degradation of image quality can be avoided even when a recording medium such as glossy paper, which is supposed to be used for recording with the recording heads at the normal position, is used with the recording heads at the cardboard position. According to the present embodiment, the vertical sliding surface 50b of the carriage 50 slides along the guide rail 52 during printing at the normal position and the vertical sliding surface 58b of the slide member 58 slides along the guide rail 52 during printing at the cardboard position. With this configuration, the carriage 50 slides directly during printing at the normal position for high recording quality, and consequently degradation of accuracy due to increase in the number of involved parts can be avoided.

Also, the present embodiment allows the recording head-to-platen distance to be switched according to the paper type and size selected on a driver. Consequently, the recording head-to-platen distance can be switched automatically when necessary. Furthermore, according to the present embodiment, displacement of the carriage unit 5a in the height direction is carried out only by translation. Therefore, the recording head-to-platen distance between the recording heads 7 and platen 34, and thus the height position of the carriage, can be switched by maintaining parallelism and without tilting the carriage 50 (recording heads 7) with respect to the recording surface of the recording medium. This prevents degradation of image recording quality when the recording head-to-platen distance is switched and thereby enables higher-quality image recording.

Next, the recovery operation of the recording heads according to the present embodiment will be described.

To perform the recovery operation including absorption of ink and wiping of the discharge surfaces, it is necessary to reduce the regulating section distance in advance. In other word, it is necessary to increase the recording head-to-platen distance by setting the carriage 50 to the cardboard position.

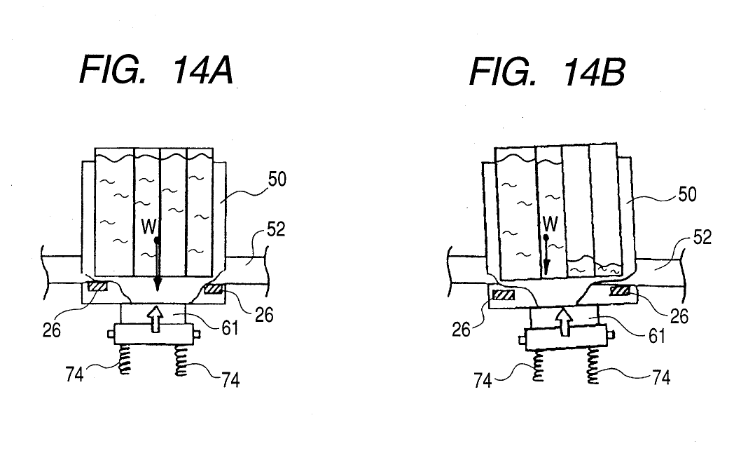

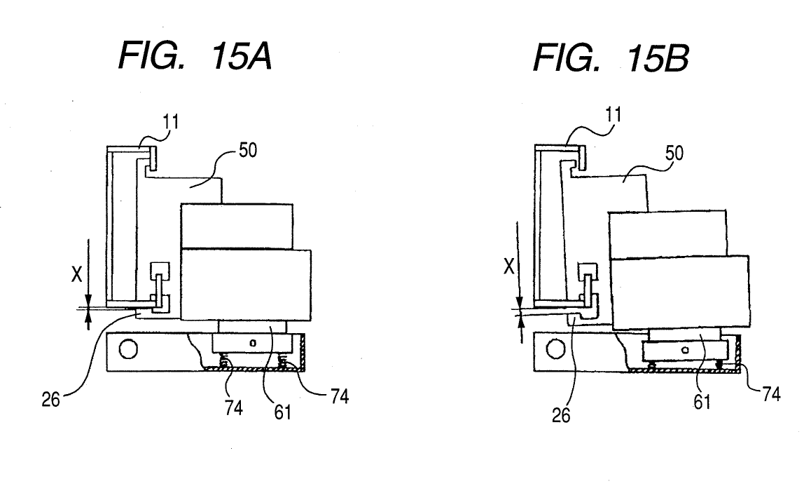

A relationship between carriage tilt and capping, which is one of the reasons for the need to reduce the regulating section distance, will be described with reference to FIGS. 14A to 15B.

FIGS. 14A to 15B are schematic front views and side views illustrating capped recording heads.

FIG. 14A shows the carriage 50 with the ink tanks filled with ink. FIG. 14B shows the carriage 50 with the ink consumed.

As shown in FIG. 14A, when the ink tanks are filled with ink, the center of gravity W of the carriage 50 and position of the cap 61 are in balance. Also, clearances between the guide rail 52 and the regulating sections 26 of the carriage 50 are balanced or the right and left regulating sections 26 are in contact with the undersurface of the guide rail. Consequently, biasing force of cap springs 74 act uniformly on the cap 61, allowing the cap 61 to cover the recording heads securely.

On the other hand, as shown in FIG. 14B, if ink levels fall unevenly as the ink is discharged for recording, the center of gravity W of the carriage 50 will shift to one side. In that case, the recording heads are capped while the carriage is tilted due to such factors as friction between the carriage 50 and the guide rail 52 which is a support member of the carriage 50. Consequently, since the cap 61 is an elastic member, the spring force which causes the cap 61 to abut the recording heads will be thrown out of balance, making it difficult for the cap 61 and recording heads to abut evenly against each other. This may result in inability to provide desired capping performance.

In order to improve capping performance by preventing the carriage 50 from tilting, it is conceivable to increase action force of the cap springs 74. However, increases in action force of the recovery unit 6 for the purpose of capping will result in the need to also increase torque of the motor 90 and rigidity of the recovery unit 6 as a whole. Thus, it is not desirable to increase the force of the cap springs 74 from the viewpoint of cost and equipment downsizing.

Now, a relationship between the regulating section distance and the carriage 50 will be described with reference to FIGS. 15A to 15B, where the regulating section distance is the clearances between the regulating sections 26 of the carriage 50 and the guide rail 52.

FIG. 15A shows a case in which the regulating section distance X is small. FIG. 15B shows a case in which the regulating section distance X is larger than in FIG. 15A. As described above, the regulating section distance X is referred to herein as first distance when it is large, and as second distance when it is smaller than the first distance. Thus, it can be seen that the larger the regulating section distance, the larger the tilting of the carriage 50. Therefore, to improve capping performance, it is desirable to perform capping with the regulating section distance reduced (i.e. the cardboard position).

Regarding wiping, it is necessary to place the wiper 62 in uniform contact with the discharge surfaces. For that, it is desirable to decrease the regulating section distance and thereby reduce the tilting of the carriage 50.

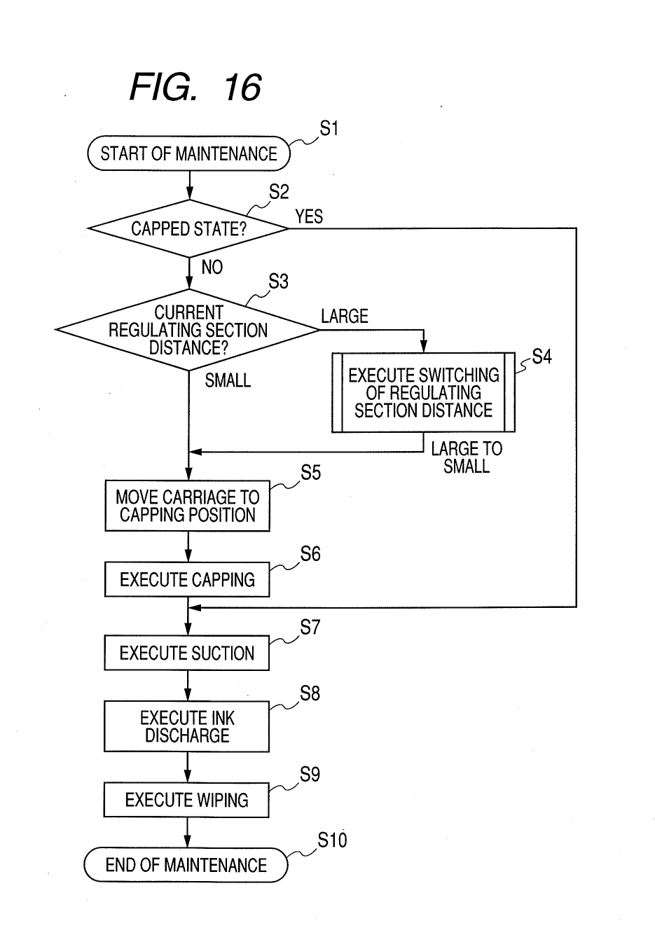

Next, a control flow of a recovery operation performed on the inkjet recording apparatus according to the present embodiment will be described. FIG. 16 is a flowchart of a recovery operation of the recording head.

When a maintenance operation is started (Step S1), the control unit 200 determines whether the recording heads are capped (Step S2). The recording heads are capped when the regulating section distance is small (second distance), i.e., when the recording head-to-platen distance is large. Thus, by determining whether the recording heads are capped, it is possible to determine whether the regulating section distance is small (the recording head-to-platen distance is large).

If it is determined that the recording heads are capped, the control unit 200 determines that the regulating section distance is small (the recording head-to-platen distance is large) and thereby starts a suction operation (Step S7).

On the other hand, if it is determined that the recording heads are not capped, the control unit 200 determines whether the recording head-to-platen distance is large or small (Step S3).

If it is determined that the recording head-to-platen distance is small, meaning that the regulating section distance is large, the control unit 200 performs a sequence of operations to switch the regulating section distance (Step S4). Specifically, to switch the regulating section distance from large to small, the control unit 200 moves the carriage unit 5a rightward in FIGS. 10 and 11. Consequently, the right end 583b of the switching member 583 hits the chassis 11, switching the regulating section distance to small.

After the regulating section distance is switched to small in Step S4, the carriage unit 5a moves to a capping position (Step S5).

If it is determined in Step S3 that the regulating section distance is small (the recording head-to-platen distance is large), the carriage unit 5a also moves to the capping position (Step S5).

After the carriage unit 5a moves to the capping position, the recording heads are capped (Step S6). Subsequently, the control unit 200 performs a suction operation (Step S7), ink discharge operation (Step S8), and wiping operation (Step S9) in sequence, and thereby finishes the maintenance operation (Step S10).

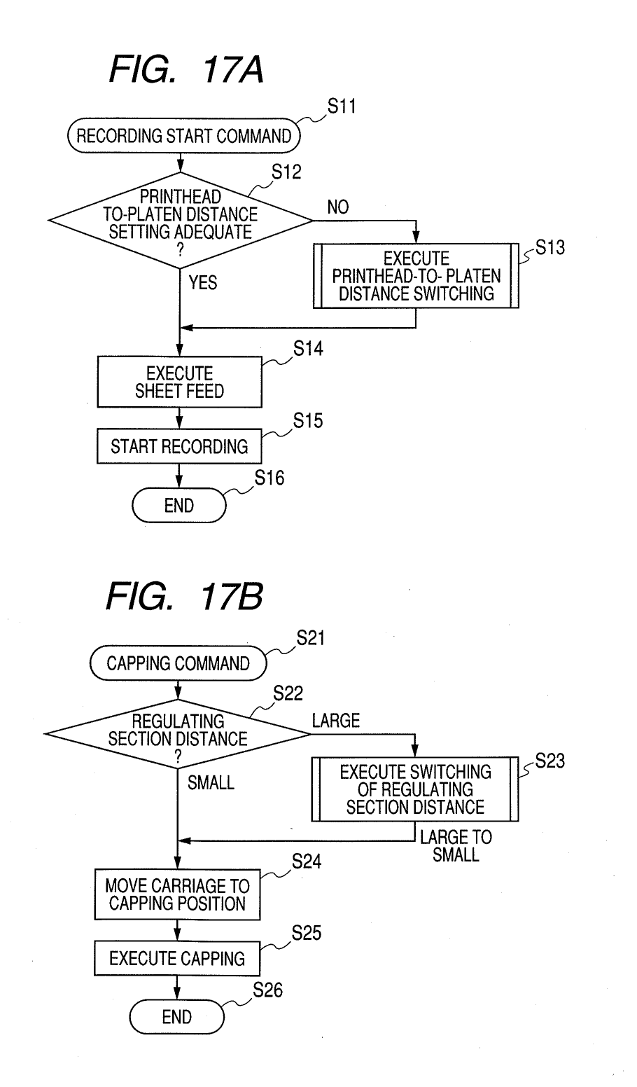

Next, a control flow of a recording operation performed on the inkjet recording apparatus according to the present embodiment will be described. FIG. 17A is a flowchart of a recording operation.

When a recording start command is given (Step S11), the control unit 200 determines whether the recording head-to-platen distance is appropriate (Step S12).

If plain paper is selected as a recording medium and the recording head-to-platen distance is small, or if a cardboard is selected and the recording head-to-platen distance is large, the recording head-to-platen distance is determined to be appropriate. In that case, the control unit 200 proceeds to perform a paper feed operation (Step S14).

Conversely, if the selected recording medium is plain paper and the recording head-to-platen distance is large, or if a cardboard is selected and the recording head-to-platen distance is small, the recording head-to-platen distance is determined to be inappropriate. In that case, the control unit 200 performs a sequence of operations to switch the recording head-to-platen distance to an appropriate setting (Step S13).

To switch the recording head-to-platen distance from small to large, the control unit 200 moves the carriage unit 5a rightward in FIGS. 10 and 11. Consequently, the recording head-to-platen distance is switched to large.

On the other hand, to switch the recording head-to-platen distance from large to small, the control unit 200 moves the carriage unit 5a leftward in FIGS. 10 and 11. Consequently, the recording head-to-platen distance is switched to small.

Once the recording head-to-platen distance is set appropriately, the control unit 200 performs a paper feed operation (Step S14) and starts a recording operation (Step S15). After predetermined recording, the control unit 200 finishes the recording operation (Step S16).

Next, a control flow of a capping operation performed on the inkjet recording apparatus according to the present embodiment will be described. FIG. 17B is a flowchart of a capping operation.

When a capping command is given (Step S21), the control unit 200 determines whether the regulating section distance is small (Step S22).

If it is determined that the regulating section distance is small, the carriage unit 5a moves to a capping position (Step S24).

On the other hand, if it is determined that the regulating section distance is large, the control unit 200 performs a sequence of operations to switch the regulating section distance (Step S23). To switch the regulating section distance from large to small, the control unit 200 moves the carriage unit 5a rightward in FIGS. 10 and 11. Consequently, the regulating section distance is switched to small.

After the regulating section distance is switched to small, the carriage unit 5a moves to a capping position (Step S24).

Subsequently, the control unit 200 caps the recording heads (Step S25) and finishes the capping operation (Step S26).

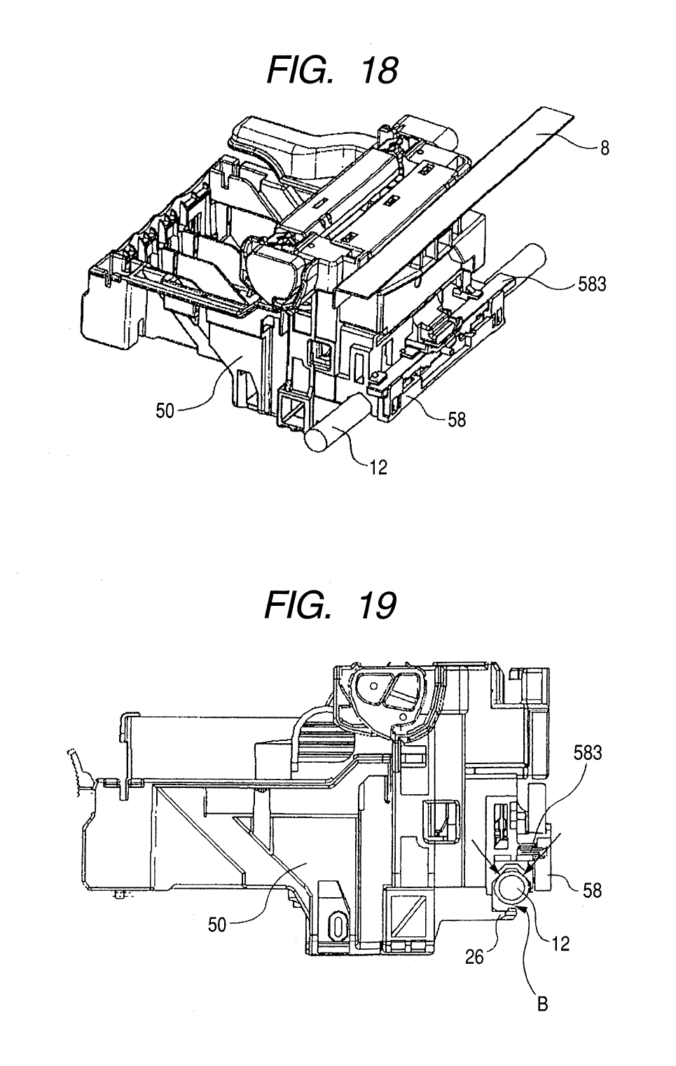

It has been described that the present invention is applicable to a recording apparatus in which the guide rail 52 is made of sheet metal. However, even if the guide rail 52 is made of a shaft member instead of sheet metal, the present invention is applicable if a configuration shown in FIGS. 18 and 19 is used.

FIG. 18 is a top perspective view of a carriage illustrating a configuration in which a guide shaft (12) is used as a carriage support member. FIG. 19 is a side view of the carriage illustrating the configuration in which the guide shaft is used as the carriage support member.

A guide shaft 12 supports the carriage 50 at the two points indicated by the arrows in FIG. 19. With this configuration, the regulating section distance is measured from the regulating sections 26 to an underside of the guide shaft 12. Since the carriage 50 is supported at the two points instead of using a configuration in which the guide shaft 12 passes through a through-hole formed in the carriage 50, the carriage 50 can move in a direction perpendicular to the recording medium. That is, the present invention is applicable to any configuration as long as the carriage 50 can move in a direction perpendicular to the recording medium even if the carriage 50 is supported by the guide shaft 12.

In the embodiment described above, an inkjet recording apparatus which ejects ink from recording heads has been taken as an example. However, the present invention is not limited to this and is applicable to apparatus of other types as long as the apparatus operates with heads spaced from a substrate. Also, the present invention is applicable regardless of the number or layout of the heads. In the case of inkjet recording apparatus, the present invention is applicable regardless of types or properties of ink they use. Furthermore, the present invention is not limited to single-function apparatus such as a printer, copier, facsimile machine, or image pickup/image forming apparatus, and is widely applicable to composite apparatus thereof or to a recording apparatus in a composite apparatus such as a computer system. Regarding substrates, the present invention can use various materials in various forms including, for example, paper, cloth, plastic sheets, OHP sheets, and envelopes, provided that images can be formed thereon.

The embodiments of the present invention provide a recording apparatus and recovery method which can properly perform a recovery operation of recording heads using a simple, inexpensive configuration.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-209184, filed Aug. 10, 2007, which is hereby incorporated by reference in its entirety.

What is claimed is:

1. An inkjet apparatus for discharging ink from a recording head, comprising:
a carriage adapted to carry a recording head;
a platen which is configured to support a substrate at a position facing the recording head when being carried by the carriage;
a slide member mounted on the carriage, and being moveable relative to the carriage between a first position and a second position;
a drive unit which is configured to move the slide member to the first position or the second position;
a guide member which is configured to guide movement of the carriage by allowing the carriage to slide along the guide member when the slide member is in the second position, and by allowing the slide member to slide along the guide member when the slide member is in the first position, wherein the distance between the recording head and the platen is larger when the slide member slides along the guide member than when the carriage slides along the guide member;
a recovery unit for maintaining the characteristics of the recording head; and
a control unit which is configured to move the slide member to the second position before moving the carriage to the recovery means by sliding the slide member along the guide member.

2. The inkjet apparatus according to claim 1, wherein the drive unit is moved relative to the carriage in a travel direction of the carriage to move the slide member.

3. The inkjet apparatus according to claim 2, wherein the drive unit comprises a switching member which is configured to contact a part of the body of the apparatus to determine the relative movement of the switching member relative to the apparatus body.

4. The inkjet apparatus according to claim 1, further comprising a storage unit configured to store the distance between the recording head and the platen.

5. The inkjet apparatus according to claim 4, wherein when the carriage is located at the recovery unit, it is determined that the distance between the recording head and the platen corresponds to the distance when the slide member slides along the guide member.

6. The inkjet apparatus according to claim 1, wherein when recording an image on a plain paper substrate, the carriage slides along the guide member.

7. The inkjet apparatus according to claim 1, wherein when recording an image on a cardboard substrate, the slide member slides along the guide member.

8. The inkjet apparatus according to claim 1, including a regulating section configured to regulate movement of the carriage, the regulating section being provided on a side of the guide member opposite to the side of the guide member in contact with the carriage or the slide member.

9. The inkjet apparatus according to claim 8, wherein the distance between the regulating section and the guide member is larger when the carriage slides along the guide member than when the slide member slides along the guide member.

10. An inkjet apparatus as claimed in claim 1 in which the slide member in the first position does not protrude from the carriage and in the second position protrudes from the carriage.

11. A recovery method for an inkjet recording apparatus which performs recording on a substrate by discharging ink from a recording head, the apparatus comprising:
a platen which supports the substrate at a position facing the recording head mounted in a carriage;
a slide member which can move to a first position or a second position with respect to the carriage;
a guide member which guides movement of the carriage by sliding of the slide member on the guide means when the slide member is at the first position, and which guides movement of the carriage by sliding of the carriage on the guide member when the slide member is at the first position; and
a recovery unit which maintains the characteristics of the recording head;
the recovery method comprising:
moving the slide member to the second position during recording on the substrate; and
moving the carriage to the recovery unit by making the slide member slide along the guide member after the slide member moves to the second position.
